(19) United States
(12) Patent Application Publication
(10) Pub. No.: US 2025/0336079 A1
(43) Pub. Date: Oct. 30, 2025

(54) SYSTEM AND METHOD FOR CALCULATING THE PERCENTAGE OF SURFACE AREA FROM IMAGE PROCESSING

(71) Applicants: PETRÓLEO BRASILEIRO S.A. - PETROBRAS, Rio de Janeiro (BR); PONTIFlCIA UNIVERSIDADE CATÓLICA DO RIO DE JANEIRO, Rio de Janeiro, RJ (BR); UNIVERSIDADE FEDERAL FLUMINENSE - UFF, Niterói, RJ (BR)

(72) Inventors: Robinson Luiz Souza Garcia, Rio de Janeiro (BR); Raul Queiroz Feitosa, Rio de Janeiro (BR); Patrick Nigri Happ, Rio de Janeiro (BR); Raphael Dos Santos Evangelista, Niteroi (BR); Lucas Bertelli Martins, Niteroi (BR); Esteban Walter Gonzalez Clua, Niteroi (BR); Marcos Do Amaral De Almeida, Niteroi (BR); Leandro Augusto Frata Fernandes, Niteroi (BR)

(21) Appl. No.: 19/185,810

(22) Filed: Apr. 22, 2025

(30) Foreign Application Priority Data
Apr. 26, 2024 (BR) 1020240081943

(51) Int. Cl. G06T 7/62; G06T 7/10; G06T 7/50; G06T 7/80

(52) U.S. Cl. CPC G06T 7/62; G06T 7/10; G06T 7/50; G06T 7/80; G06T 2207/20081

(57) ABSTRACT

A method for determining the percentage of corroded area from an image, which may be a photograph or a frame from a video. The system includes four main modules: M1—Surface geometry estimation module; M2—Corrosion segmentation module that performs image segmentation to identify corroded and non-corroded surfaces; M3—Optional surface class segmentation module that performs image segmentation to group surfaces by industrial object classes or by specific objects; and M4—Module for calculating the percentage of corroded area.

### FIELD OF THE INVENTION

The present invention falls within the field of imaging. More specifically, the present invention is related to techniques for calculating a percentage of area affected by corrosion from images of equipment or offshore environments.

### BACKGROUND OF THE INVENTION

Calculating the percentage of corrosion per object depends on measuring the corroded area and the area of the object in question. However, there are obstacles to obtaining these two values efficiently. First, measuring the area of the corroded surface is complex, since it does not follow a simple geometric pattern. It can take on different forms, which requires time-consuming and cost-intensive on-site measurement methods. If it is not possible to perform the measurement directly, we have the worst-case scenario, which is a subjective estimate made by an inspector. The measurement of the total area, in its turn, can be obtained through 3D engineering models, however, this requires a considerable expenditure of man-hours to identify each object, estimate its surface area in the three-dimensional model and record this together with some estimate of the corroded area. In addition to being counterproductive, this method is limited by the degree of updating of these models, which follow a continuous as-built process given that offshore units undergo constant modifications. In addition, smaller components may not be identified in the 3D model.

It is important to highlight that the structures of each environment can be measured directly using laser scanners that produce three-dimensional point clouds. Point clouds are a type of base information that can be used to estimate the real surface area with relative accuracy. However, the use of laser scanners is still restricted due to limitations related to the number of people on board the platform (POB) and the time required to perform a complete scan. In addition, their complexity and operating cost are also factors that contribute to this restriction today. Capture productivity is still low due to the small number of images that can be taken during a 15-day campaign. However, point clouds themselves do not delimit corrosion, which means that the challenge of delimiting the corrosion area based on visual content remains.

Currently, the most common corrosion measurement techniques include: 1) measuring all corrosion points on the unit with a tape measure, which is unfeasible due to the number of corrosion points and inaccurate because their shape does not follow a coherent geometric pattern; 2) estimating the percentage of corrosion on equipment based on a visual perception of the inspector, which is a subjective method, increasing the risk of inadequate comparisons between measurements made on different units by different inspectors; 3) using a portable scanner, which is inefficient due to the number of corrosion points and the processing time for each image.

### STATE OF THE ART

The document US 2023131469 A1, entitled “Methods of artificial intelligence-assisted infrastructure assessment using mixed reality systems”, discloses a hybrid system for non-contact inspection of structures including a front-end module that includes a mixed reality headset in communication with a user input actuator. The mixed reality headset is configured to scan a surrounding area and capture images within the surrounding area to detect a defect in a structure disposed in the surrounding area. The user input actuator is configured to receive a selection from a user to investigate a portion of the surrounding area. As such, the mixed reality headset captures an image of a portion of the surrounding area. The hybrid system also includes a back-end module including a server in wireless communication with the mixed reality headset. The server includes a deep learning module with a trained dataset of defects in structures and is configured to receive the captured image of the portion of the surrounding area from the mixed reality headset. The deep learning module is configured to compare the captured image of the portion of the surrounding area with the trained dataset of defects in the structure to determine the presence of a defect. In one embodiment, the server is configured to segment the captured image of the portion of the surrounding area only within the bounding box, thereby focusing the comparison performed by the deep learning module on the segmented image within the bounding box.

The document CN 117152749 A, entitled “Power transmission line iron tower angle steel corrosion assessment method and system based on multilayer segmentation”, discloses a power transmission line iron tower angle steel corrosion assessment method and system based on multilayer segmentation, and the method comprises the steps of: performing instance segmentation of an image of a power transmission line iron tower and obtaining the instance of each angle steel; performing semantic segmentation on the single angle steel to obtain a corrosion area on the corresponding angle steel; calculating the corrosion rate of each angle steel; and performing the weighted average of the corrosion proportions of all steel angles to obtain the overall corrosion proportion of the power transmission line iron tower and further evaluate the overall corrosion degree of the power transmission line iron tower, through a sample and the detection of the intensity.

### SUMMARY OF THE INVENTION

The present invention comprises a system for calculating a percentage of area affected by corrosion, the system comprising a first main module, a second main module and an optional module that analyze images or video frames taken of the environment to be inspected. The first main module extracts intrinsic and extrinsic characteristics of the images and describes a depth map thereof. The second main module performs segmentation on the images to determine pixels where there is corrosion by means of a first trained Artificial Intelligence (AI). This segmentation can be semantic, by instance or panoptic. The optional module also performs segmentation on the images to determine what type of object each pixel belongs to, by means of a second trained Al. Finally, a fourth module combines the data obtained by the other modules and calculates the percentage of area with corrosion for each image or for each piece of equipment identified in the image.

### BRIEF DESCRIPTION OF THE DRAWINGS

The present invention will be described below with reference to its typical embodiments and, also, with reference to the attached drawings.

FIG. 1 is a representation of a street view of photospheres, according to the present invention.

FIG. 2 is a representation of a viewing angle of one of the photospheres and its indication on the map, according to the present invention.

FIG. 3 is a representation of the arrangement of the main modules of the invention.

FIG. 4 is a detailed view of module M1, according to the present invention.

FIG. 5 is a detailed view of module M2, according to the present invention.

FIG. 6 is a detailed view of module M3, according to the present invention.

FIG. 7 is a detailed view of module M4, according to the present invention.

### DETAILED DESCRIPTION OF THE INVENTION

Specific embodiments of the present disclosure are described below. In an effort to provide a concise description of these embodiments, all features of an actual implementation may not be described in the specification. It should be appreciated that in the development of any real-world implementation, as in any engineering or design project, numerous implementation-specific decisions must be made to achieve the specific objectives of the developers, such as compliance with system and business-related constraints, which may vary from one implementation to another. Furthermore, it should be appreciated that such a development effort may be complex and time-consuming but would nevertheless be a routine design and fabrication undertaking for those of ordinary skill having the benefit of this disclosure.

An oil production platform consists of a large ship hull on which numerous pieces of equipment required for the primary processing of oil are installed. This structure is intended to meet the regulatory requirements for exporting oil and gas, as well as for disposing or reinjecting produced water. The equipment is part of the topside structure of the vessel and may be composed of metallic and non-metallic parts. Over time, the metallic parts eventually corrode, a phenomenon that is accelerated by adverse environmental conditions. In general, the platform is divided into plants, with the larger plants being subdivided into areas. Images obtained inside the areas or plants are evaluated to determine the percentage of area affected by corrosion in each one, or in each piece of equipment/structure individually.

There are many ways to obtain these images using various photography or video recording techniques. One technique that stands out among these is 3D photospheres, which allow a street view-like visualization of the plant/area with the possibility of navigation. To obtain such images, a data collection team must periodically board the platform to capture the spherical photos in a grid with approximately 2 meters of interval. These photospheres are properly georeferenced in the plant areas, allowing navigation between them to observe the corroded areas.

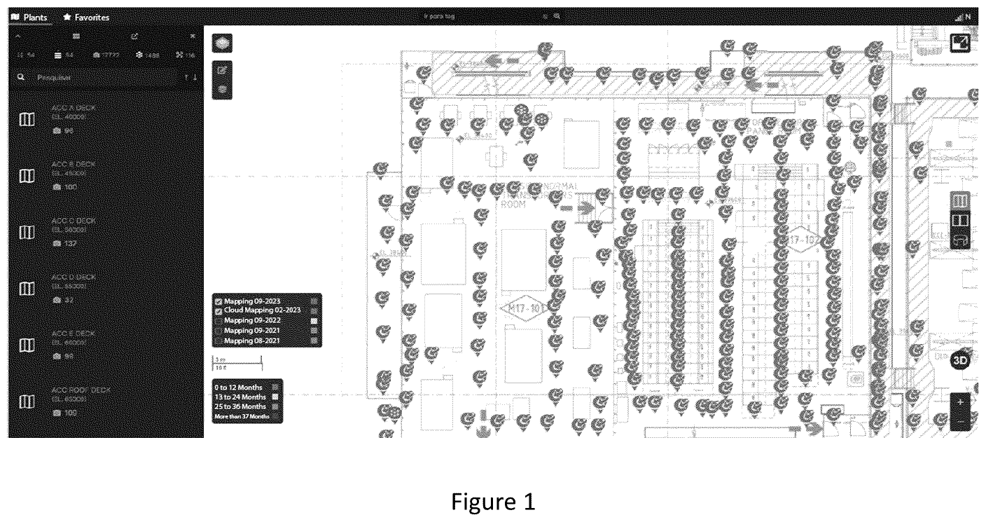

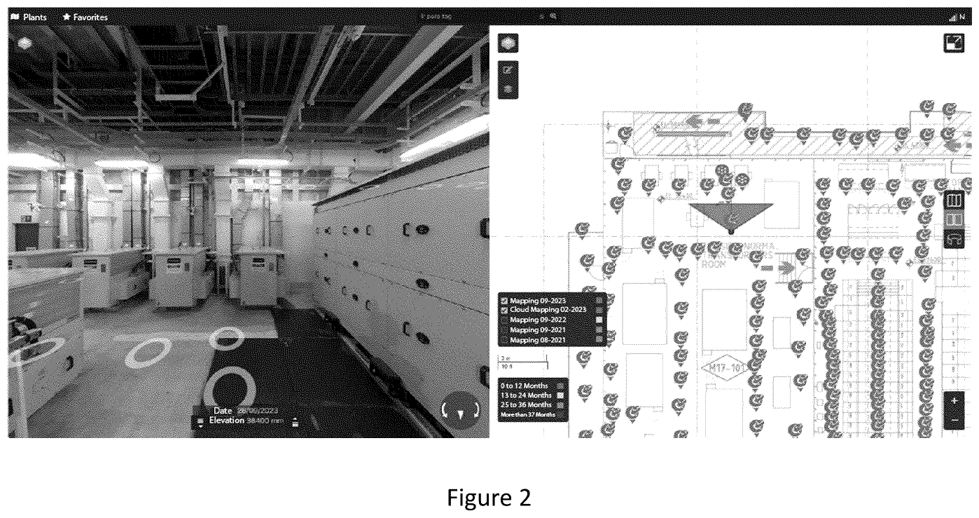

The images obtained will be the data used as input for the method of the present invention. Advantageously, each photosphere is accompanied by various metadata that help to identify and qualify them. FIG. 1 shows an example of a map with photospheres according to the present invention, where each green icon is a photosphere. FIG. 2 illustrates a viewing angle of one of the photospheres, indicated on the map on the right.

As shown in FIG. 1, the starting point for the process of calculating the relative area of surface corrosion is a set of colored images E. The colored images E are captured at the location where the area affected by corrosion is to be determined. The colored images E can be obtained by photography or can be video frames, with each frame of the video being treated as an independent image. The image shape can also vary in terms of resolution and type of projection. In other words, both projective images and omnidirectional images are accepted as input, and the latter, when available, are converted into projective images by using cube maps or any other mapping that generates as a result a set of projective images.

The present invention consists of a computer system comprising a first main module (M1), a second main module (M2), and a fourth main module (M4). The computer system can additionally comprise an optional third main module (M3). Each of these modules performs specific tasks related to the processing of the images obtained and can be divided into multiple submodules. The four main modules that compose the system are listed below:

M1—Surface geometry estimation module;

M2—Corrosion segmentation module that segments images to identify corroded and non-corroded surfaces;

M3—Surface class segmentation module that segments images to group surfaces by industrial object classes or by specific objects. This module is optional, applied only when it is desired to calculate the percentage of corroded area considering the partitioning of surfaces by surface type;

M4—Module for calculating the percentage of corroded area.

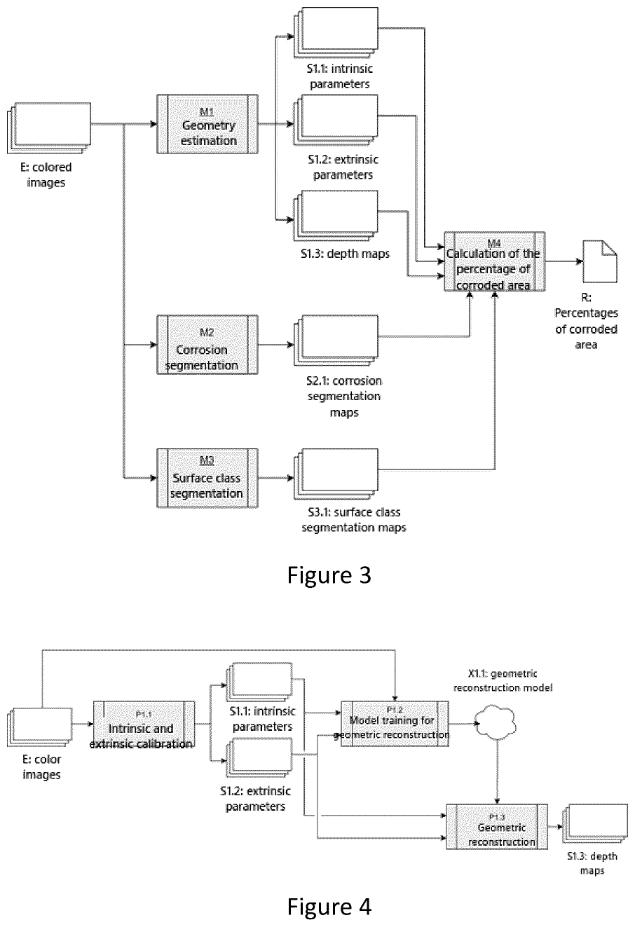

FIG. 3 illustrates the relationship between the four main modules of the invention. As input to modules M1, M2 and M3, color images (E) are provided, whether individual or frames from a video, captured at the location where the area percentages will be calculated. The input of module M4 is the outputs of the other modules M1, M2 and M3, with M4 being responsible for producing the corrosion area percentages (R) as a result.

For each input image, module M1 emits three outputs:
Output S1.1: internal camera parameters, such as focal length, main point in pixels, pixel size, tilt coefficient of the image plane axes and lens distortion modeling;
Output S1.2: 3D location and orientation of the cameras used to capture the input images E;
Output S1.3: a depth map.

The name given in the literature to the process that calculates output S1.1 is “intrinsic calibration” and for S1.2 “extrinsic calibration” of the cameras. The intrinsic and extrinsic calibration processes are well known in the literature, so they will not be described in detail here.

The depth map resulting from the output S1.3 is obtained by associating each pixel of the image E with information on the distance between the projection center of the camera used to capture the image (i.e., the location of the camera in 3D space, obtained from the output in S1.2 via extrinsic calibration) and the visible surface where the pixel is located. The depth map can be produced by any computer vision process. For example and without limitation, active triangulation processes (e.g., using laser or infrared light scanners), passive triangulation processes (e.g., using epipolar geometry and multiple views of the scene for surface estimation), monocular depth estimation processes, e.g., using radiance fields for volumetric representation of the environment by radiance fields, preferably NeRFs, and subsequent estimation of depth maps from arbitrary viewpoints, may be used.

The module M2 processes each input image E and emits, as output S2.1, for each image, a map that associates a label to each of the pixels in each image. The label is a classification of whether or not the pixel represents a corroded surface. The process of associating labels to image pixels in order to obtain a set of regions that share a common characteristic is known in the literature as “image segmentation”. There are several suitable techniques for performing image segmentation from module M2. For example, and without limitation, a very effective technique is the use of a previously trained artificial intelligence (AI) for automatic identification of each pixel. The AI can be, for example, an artificial neural network (ANN), a convolutional neural network (CNN), or a support vector machine (SVM), but is not limited to them.

The module M3, which is optional, also performs a surface class segmentation of the images and emits an output S3.1 comprising a segmentation map. In this case, the labels indicate what type of object the visible surface where the pixel is located is associated with. For example, the visible surface where the pixel is located can be an engine, a pipe, a door, or any other equipment or structure of the plant or area. Similar to the module M2, any image segmentation technique considered suitable can be used, such as the use of AI.

FIG. 4 illustrates the case in which NeRFs are used as the geometric reconstruction model X1.1 in the estimation of depth maps. In this materialization of module M1, process P1.1 corresponds to any intrinsic and extrinsic calibration technique available in the literature, such as a structure-from-motion (SfM) technique. Process P1.2 is responsible for training the geometric reconstruction model X1.1 so that, once trained, it can be applied in process P1.3 to reconstruct the scene within the 3D space and, consequently, allow the extraction of a depth map S1.3 for each image provided as input. The training performed in process P1.2 can be executed previously, with color and depth data obtained in any environments or even from public datasets, as in the case of monocular depth estimation techniques, and refined with the intrinsic parameters S1.1 and extrinsic parameters S1.2 and with the color images E, so that, at analysis time, the trained model X1.1 is applied in process P1.3 or training in the P1.2 process can be performed immediately before analysis, using only the color images E and the parameters S1.1 and S1.2, as is the case when NeRFs are used as a geometric reconstruction model.

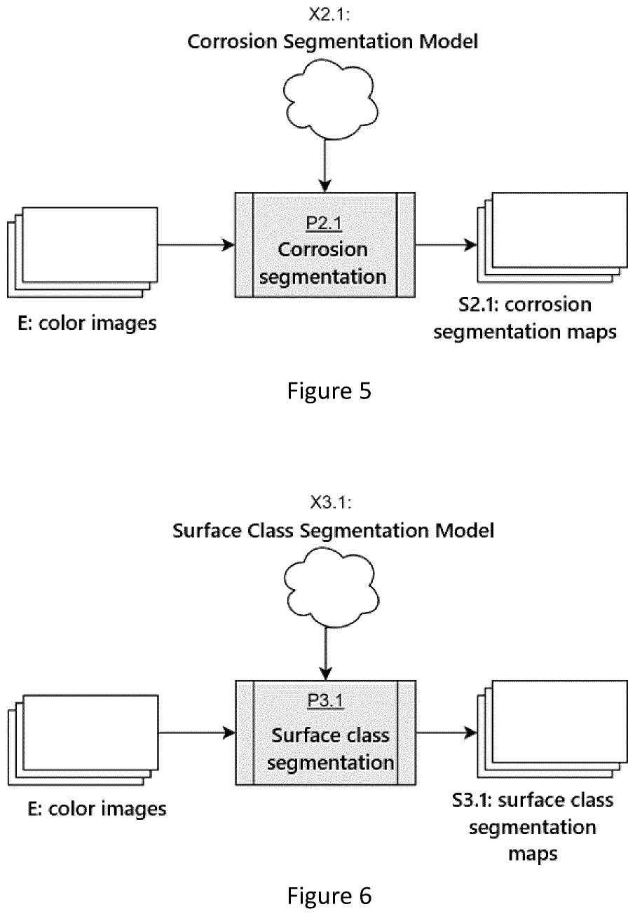

FIG. 5 and FIG. 6 illustrate the application of image segmentation models X2.1 and X3.1, respectively, in processes P2.1 and P3.1 to generate the segmentation maps emitted at outputs S2.1 and S3.1. These models employ image segmentation techniques which may be based on, but are not limited to, the use of artificial neural networks trained in a supervised or unsupervised manner. The segmentation models may be employed individually or together. It is understood that processes P2.1 and P3.1 represent the application of models X2.1 and X3.1, respectively, to color images E.

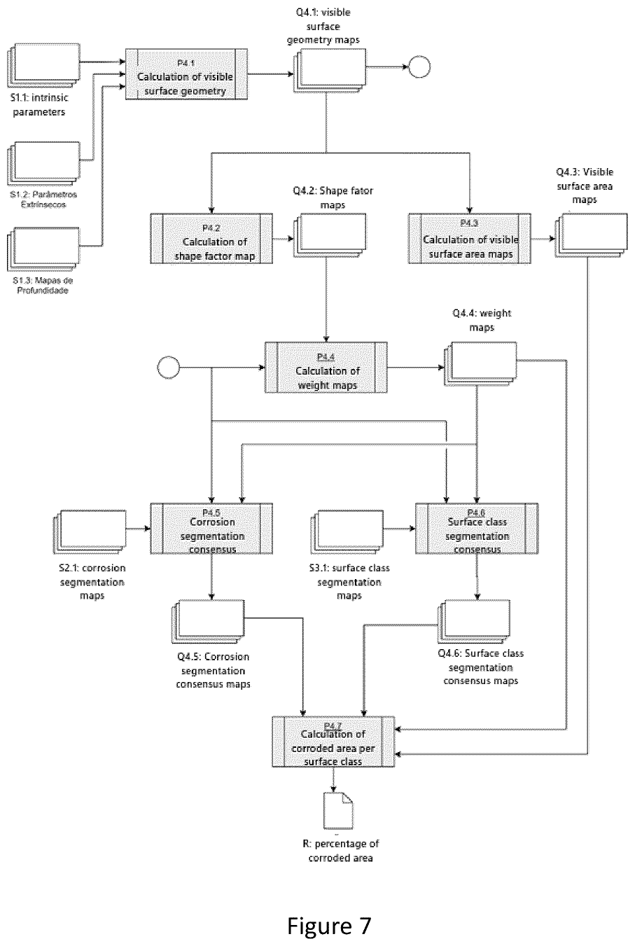

The intrinsic (S1.1) and extrinsic (S1.2) calibrations, depth maps (S1.3) and segmentation maps (S2.1 and S3.1) serve as input for module M4 to continue the process of calculating corrosion area percentages, as illustrated in FIG. 3. The list of processes that compose module M4 is illustrated in FIG. 7.

Since it is likely and desirable that the same portion of a surface is recorded from different viewpoints (i.e., different images from the input set E), it is necessary to provide a criterion that helps in weighting the information coming from each viewpoint for this portion of the surface. Preferably, but without limitation, the criterion is the shape factor, which consists of a metric that emits real values between 0 and 1, where 0 indicates that the viewpoint is not suitable for representing the surface while 1 indicates that the viewpoint is ideal for representing the surface. The shape factor is calculated for each pixel of each color image given as input and, in its calculation, weighs the angle formed by the surface normal vector and the direction of the optical axis of the camera (the more aligned and with opposite directions these vectors are, the better), and the distance between the projection center and the surface of the camera (the closer, the better). As shown in FIG. 7, the shape factor maps Q4.2 are calculated by process P4.2, which receives as input information from the visible geometry maps, Q4.1, calculated by process P4.1, from the depth map S1.3 obtained for the viewpoint, that is, for the color image E in question, from the intrinsic calibration S1.1 and extrinsic calibration S1.2.

As an example of the implementation of process P4.1, it is suggested to use back projection of the image pixels from each viewpoint to the world coordinate system, with the application of the depth map as a criterion for breaking the projective ambiguity. The back projected pixels result in a cloud of points that, when connected based on their neighborhoods in the original images, produce a mesh of quadrilaterals or a mesh of triangles that approximates the true surface and that represent the implementation of maps Q4.1. The back projection procedure suggested here is widely known in the field of computer vision and is present in textbooks that cover photogrammetry.

The calculation of the shape factor, performed in the process P4.2, is known in the computer graphics literature, and the shape factor was originally proposed in 1986 by Kajiya in the article “The Rendering Equation” (DOI: 10.1145/15922.15902).

The visible geometry maps Q4.1 associate to each pixel of each color image E the 3D coordinates of the central point of the surface portion seen by the pixel and the normal vector of the surface at that point. These maps are also used as input to process P4.3, which is responsible for calculating the visible surface area maps Q4.3. If, as exemplified above, quadrilateral or triangle meshes are used to create maps Q4.1, then the implementation of process P4.3 occurs preferably by adding the area of the quadrilaterals or pair of triangles associated with a given pixel and whose normal vectors indicate that that portion of the surface is visible from the point of view considered. The maps Q4.3 associate to each pixel of the input images an estimate of the area of the surface visible by the pixel.

The shape factor maps Q4.2 and the visible surface area maps Q4.3, individually, do not provide the weighting information needed for relative surface area estimation. This is because, as previously mentioned, it is likely and desirable that the same portion of the surface is recorded from different viewpoints. However, the maps Q4.2 provide non-normalized weights to be used in this weighting. As illustrated in FIG. 7, the combination of the information contained in the visible surface geometry maps Q4.1 and the shape factor maps Q4.2 leads the process P4.4 to compute weight maps Q4.4 that will be used in the weighting of the area information, prioritizing the best views of the surfaces.

An example of how to perform process P4.4 is by discretizing the coordinates of the back projected pixels so that these coordinates unambiguously indicate the voxels of the space through which the visible surface passes through each pixel. The normalization that leads to the calculation of the maps Q4.4 occurs by identifying portions of voxels observed simultaneously from more than one viewpoint and using this information to scale the shape factors of these pixels so that they collectively add up to 1.

Once the weight maps Q4.4 have been calculated, it is possible to adjust the segmentation maps S2.1 and S3.1 so that they reach consensus, since, just like manual segmentation performed by different experts, automatic segmentation performed independently on each of the input images E (FIGS. 5 and 6) is subject to failures due to, for example, a lack of adequacy of the viewpoints. The consensus processes P4.5 and P4.6 illustrated in FIG. 7, therefore, aim to unify the segmentation of the same view. Consensus is achieved by means of a voting algorithm that generates, for each input image, an updated segmentation map that receives as votes the weights stored in Q4.4 according to the geometry visible simultaneously from different viewpoints and maintained in the maps Q4.1.

As a final step, executed by process P4.7, the total area of a type of surface with or without corrosion, identified in the consensus-corrected segmentation maps Q4.6 and Q4.6, is given by the sum of the surface areas Q4.3, weighted by the weight maps Q4.4. The relative areas R are given by dividing the corroded surface area of a type (for example, corroded pipe surface area) by the total area of that type of surface (for example, total pipe surface area).

A validation test calculating the corrosion percentage was performed by 3 (three) inspectors for 5 (five) sectors of 3 (three) offshore production platforms. The inspectors were given the standard task of measuring the corrosion percentage for each type of equipment: floor, structure, pipes-valves-flanges (TVF), stairs, guardrails, ceiling and equipment. The assessment was based on a set of georeferenced images accessible in a street view tool. The same set of images was processed using the methodology being proposed. The average results of the coating integrity index, which is the equivalent of 100 minus the percentage of visible corroded area, are available for the 5 (five) sectors assessed according to table A. The rows in table A correspond to the sectors and the columns to the automatic assessment made by the method proposed in the present invention and the visual assessment by 3 (three) inspectors.

TABLE A

| | Proposed | | | |
|---|---|---|---|---|
| | method | Inspector #1 | Inspector #2 | Inspector #3 |
| Sector 1 | 95.6 | 95.0 | 96.3 | 80.1 |
| Sector 2 | 96.2 | 89.3 | 95.0 | 86.8 |
| Sector 3 | 96.1 | 85.7 | 97.2 | 71.0 |
| Sector 4 | 99.1 | 95.3 | 97.0 | 92.5 |
| Sector 5 | 99.7 | 98.4 | 99.3 | 100.0 |

Table B shows the Pearson correlation coefficients (PCC) between the coating integrity index obtained by the method of the present invention and by the inspectors. PCC values between 0.70 and 0.89 are considered a strong correlation, while values between 0.40 and 0.69 reflect a moderate correlation. When comparing the results obtained through the proposed method and the evaluations of inspectors #1 and #2, the PCC values indicate a strong correlation. When compared with inspector #3, the proposed method suggests a moderate correlation (at its upper limit). It is important to note that the PCC values suggest a moderate correlation between the inspectors themselves, largely due to the implicit subjectivity of the evaluation, which the present invention aims to eliminate.

TABLE B

| | Proposed | | | |
|---|---|---|---|---|
| | method | Inspector #1 | Inspector #2 | Inspector #3 |
| Proposed method | — | 0.83 | 0.77 | 0.69 |
| Inspector #1 | | — | 0.77 | 0.62 |
| Inspector #2 | | | — | 0.60 |
| Inspector #3 | | | | — |

Table C shows, for each class of industrial object surface (rows), the mean absolute error of the estimated coating integrity index calculated between pairs of inspectors (column “Inspector versus Inspector”) and between each inspector and the present method (column “Inspector versus Present Invention”) considering the 5 (five) sectors evaluated.

TABLE C

| | Inspector versus | Inspector versus |
|---|---|---|
| | Inspector | Present Invention |
| TVF | 4.5 | 2.6 |
| Floor | 9.4 | 7.3 |
| Ceiling | 2.0 | 1.3 |
| Structures | 4.0 | 2.9 |
| Supports | 5.4 | 4.6 |
| Equipment | 4.6 | 2.7 |
| Stairs | 1.4 | 2.9 |
| Guardrails | 2.0 | 2.6 |

Tables D to H show, respectively, for each of the 5 (five) sectors, the coating integrity index estimated for each class of industrial object surface (rows) using the method proposed in the present invention and the inspectors (columns). Values marked as N/A indicate that the inspector did not evaluate the objects of the specific class. Inspection of the results shows that an automatic system tends to respond in a manner similar to average human perception. It is observed that there is greater agreement between the system and each of the inspectors than between the inspectors themselves. The reason may be the intrinsic subjectivity of human analysis.

TABLE D

| | Proposed | | | |
|---|---|---|---|---|
| Sector 1 | method | Inspector #1 | Inspector #2 | Inspector #3 |
| TVF | 96.8 | 94.0 | 99.0 | 84.0 |
| Floor | 90.5 | 87.0 | 80.0 | 50.0 |
| Ceiling | 99.6 | 97.0 | 100.0 | 99.9 |
| Structures | 98.7 | 96.0 | 98.0 | 84.0 |
| Supports | 95.5 | 94.0 | 97.0 | 84.0 |
| Equipment | 96.7 | 97.0 | 98.0 | 99.0 |
| Stairs | 89.7 | 98.0 | 99.0 | 50.0 |
| Guardrails | 97.5 | 97.0 | 99.0 | 90.0 |

TABLE E

| | Proposed | | | |
|---|---|---|---|---|
| Sector 2 | method | Inspector #1 | Inspector #2 | Inspector #3 |
| TVF | 99.9 | 90.0 | 99.0 | 97.0 |
| Floor | 75.3 | 58.0 | 70.0 | 50.0 |
| Ceiling | 98.7 | 96.0 | 99.0 | 99.9 |
| Structures | 98.2 | 95.0 | 97.0 | 84.0 |
| Supports | 99.5 | 92.0 | 98.0 | 84.0 |
| Equipment | 99.0 | 90.0 | 99.0 | 90.0 |
| Stairs | 99.4 | 97.0 | 99.0 | 90.0 |
| Guardrail | 99.7 | 96.0 | 99.0 | 99.7 |

TABLE F

| | Proposed | | | |
|---|---|---|---|---|
| Sector 3 | method | Inspector #1 | Inspector #2 | Inspector #3 |
| TVF | 99.8 | 95.0 | 99.0 | 67.0 |
| Floor | 72.6 | 66.0 | 90.0 | 50.0 |
| Ceiling | 99.4 | N/A | N/A | 100.0 |
| Structures | 99.8 | 87.0 | 99.0 | 84.0 |
| Supports | 99.5 | 80.0 | 97.0 | 67.0 |
| Equipment | 99.9 | 90.0 | 99.0 | 99.7 |
| Stairs | 97.9 | 96.0 | 99.0 | 50.0 |
| Guardrail | 100.0 | 88.0 | N/A | 50.0 |

TABLE G

| | Proposed | | | |
|---|---|---|---|---|
| Sector 4 | method | Inspector #1 | Inspector #2 | Inspector #3 |
| TVF | 98.8 | N/A | 99.0 | 100.0 |
| Floor | 94.4 | 90.0 | 90.0 | 84.0 |
| Ceiling | 100.0 | N/A | N/A | 100.0 |
| Structures | 100.0 | 96.0 | 99.0 | 90.0 |
| Supports | 100.0 | 95.0 | 95.0 | 84.0 |
| Equipment | 98.6 | 96.0 | 99.0 | 99.0 |
| Stairs | 98.8 | 97.0 | 98.0 | 84.0 |
| Guardrail | 100.0 | 98.0 | 99.0 | 99.0 |

TABLE H

| | Proposed | | | |
|---|---|---|---|---|
| Sector 5 | method | Inspector #1 | Inspector #2 | Inspector #3 |
| TVF | 99.4 | 99.0 | 99.0 | 100.0 |
| Floor | 99.2 | 98.0 | 100.0 | 100.0 |
| Ceiling | 100.0 | 99.0 | 99.0 | 100.0 |
| Structures | 99.9 | 98.0 | 99.0 | 100.0 |
| Supports | 99.5 | 98.0 | 99.0 | 100.0 |
| Equipment | 99.6 | 98.0 | 99.0 | 100.0 |
| Stairs | 99.6 | 99.0 | 99.0 | 100.0 |
| Guardrail | 100.0 | 98.0 | 100.0 | 100.0 |

The present invention can be applied in a work process for managing the corrosion percentage in offshore environments, allowing the automatic detection of corrosion and the calculation of the coating percentage, without the need to consult 3D engineering models. The invention has the ability to analyze 2D images, whether they are captured independently or extracted from frames of a video, generating textured 3D models. This is done through the application of computer vision and artificial intelligence techniques, allowing the identification of areas with changes, such as corrosion. In addition, it is possible to group these areas by classes of industrial objects or specific objects, also using computer vision and artificial intelligence. In the oil industry, this technology can be applied to calculate the coating index in hydrocarbon production facilities.

On the other hand, the solution can be used for several other purposes, such as:
identification of flaws in paints or surface inconsistencies, such as cracks or undue discontinuities;
estimation of total area calculation for certain objects;
identification of possible areas with adverse microclimates (e.g., higher concentration of humidity at the site), which accelerate corrosion at the site and may result in critical, unforeseen damage to nearby equipment and instruments;
identification of equipment and structures with marked deterioration, indicating the possibility of preparing a preservation plan. This plan does not eliminate the need for a painting plan, but it does increase the useful life of the component/object.

Although aspects of the present disclosure may be susceptible to various modifications and alternative forms, specific embodiments have been shown, by way of example, in the drawings and have been described in detail in this document. But it should be understood that the invention is not intended to be limited to the particular forms disclosed. Rather, the invention should cover all modifications, equivalents, and alternatives that fall within the scope of the invention, as defined by the following appended claims.

1. A system for calculating the percentage of surface area from images, the system comprising:
a geometry estimation module configured to emit intrinsic parameters, extrinsic parameters, and a depth map based on the images;
a corrosion segmentation module configured to emit a corrosion segmentation map based on the images; and
a module configured to calculate the percentage of corroded area, wherein the module is configured to determine the percentage of corroded area based on the intrinsic parameters, the extrinsic parameters, the depth map, and the corrosion segmentation map.

2. The system according to claim 1, wherein the geometry estimation module is additionally configured to output the intrinsic parameters and the extrinsic parameters through an intrinsic and extrinsic calibration process.

3. The system according to claim 2, wherein the geometry estimation module is additionally configured to output the surface class segmentation map through a training process of a geometric reconstruction model that trains a model based on the images, the intrinsic parameters and the extrinsic parameters.

4. The system according to claim 1, wherein the corrosion segmentation module is additionally configured to output the corrosion segmentation map through a corrosion segmentation process based on a corrosion segmentation model.

5. The system according to claim 1, further comprising:
a surface class segmentation module configured to output a surface class segmentation map based on the images,
wherein the corroded area percentage calculation module is additionally configured to determine the percentage of the corroded area based further on the surface class segmentation map.

6. The system according to claim 5, wherein the surface class segmentation module is additionally configured to output the surface class segmentation map through a surface class segmentation process based on a surface class segmentation model.

7. The system according to claim 6, wherein the corroded area percentage calculation module is additionally configured to:
obtain a visible surface geometry map through a visible surface geometry calculation process based on the intrinsic parameters, the extrinsic parameters, and the depth map;
obtain a shape factor map through a shape factor map calculation process based on the visible surface geometry map;
obtain a visible surface area map through a visible surface area map calculation process based on the visible surface geometry map;
obtain a weight map through a weight map calculation process based on the visible surface geometry map and the shape factor map;
obtain a corrosion segmentation consensus map through a corrosion segmentation consensus process based on the visible surface geometry map, the weight map, and the corrosion segmentation map; and
obtain a surface class segmentation consensus map through a surface class segmentation consensus process based on the visible surface geometry map, the weight map, and the surface class segmentation map,
wherein the determination of the percentage of the corroded area based on the intrinsic parameters, the extrinsic parameters, the depth map, and the corrosion segmentation map comprises a process of calculating the corroded area per surface class based on the visible surface area map, the weight map, the corrosion segmentation consensus map, and the surface class segmentation consensus map.

8. A method for calculating a percentage of surface area from images, the method comprising:
emitting intrinsic parameters, extrinsic parameters and a depth map based on the images;
emitting a corrosion segmentation map based on the images; and
determining the percentage of the corroded area based on the intrinsic parameters, the extrinsic parameters, the depth map and the corrosion segmentation map.

9. The method according to claim 8, wherein emitting the intrinsic parameters and the extrinsic parameters comprises an intrinsic and extrinsic calibration.

10. The method according to claim 9, wherein emitting a surface class segmentation map comprises training of a geometric reconstruction model, wherein the training is based on the intrinsic parameters and the extrinsic parameters.

11. The method according to claim 8, wherein emitting a corrosion segmentation map comprises a corrosion segmentation based on a corrosion segmentation model.

12. The method according to claim 8, further comprising:
emitting a surface class segmentation map based on the images,
wherein the determination of the percentage of the corroded area is based additionally on the surface class segmentation map.

13. The method according to claim 12, wherein emitting the surface class segmentation map comprises a surface class segmentation based on a surface class segmentation model.

14. The method according to claim 13, wherein determining the percentage of the corroded area comprises:
calculating a visible surface geometry based on the intrinsic parameters, the extrinsic parameters, and the depth map to obtain a visible surface geometry map;
calculating a shape factor map based on the visible surface geometry map to obtain a shape factor map;
computing a visible surface area map based on the visible surface geometry map to obtain a visible surface area map;
computing a weight map based on the visible surface geometry map and the shape factor map to obtain a weight map;
obtain a corrosion segmentation consensus based on the visible surface geometry map, the weight map, and the corrosion segmentation map to obtain a corrosion segmentation consensus map; and
obtaining a surface class segmentation consensus map through a surface class segmentation consensus process based on the visible surface geometry map, the weight map, and the surface class segmentation map,
wherein determining the percentage of corroded area based on the intrinsic parameters, the extrinsic parameters, the depth map, and the corrosion segmentation map comprises calculating a corroded area per surface class based on the visible surface area map, the weight map, the corrosion segmentation consensus map, and the surface class segmentation consensus map.

15. The system according to claim 2, wherein the corrosion segmentation module is additionally configured to output the corrosion segmentation map through a corrosion segmentation process based on a corrosion segmentation model.

16. The system according to claim 3, wherein the corrosion segmentation module is additionally configured to output the corrosion segmentation map through a corrosion segmentation process based on a corrosion segmentation model.
